(19) United States
(12) Patent Application Publication
(10) Pub. No.: US 2021/0034669 A1
(43) Pub. Date: Feb. 4, 2021

(54) DYNAMIC ENDPOINT GENERATION

(71) Applicant: Instant Labs, Inc., Santa Clara, CA (US)

(72) Inventors: John McLaughlin, Roseland, NJ (US); Eric Kiebler, Half Moon Bay, CA (US); Hal Spitz, Oakland, CA (US); Rene Stein, Palo Alto, CA (US); Brigand Balleau, Albany, CA (US); Ajit Shantilal Shah, Portola Valley, CA (US)

(21) Appl. No.: 16/943,807

(22) Filed: Jul. 30, 2020

Related U.S. Application Data
(60) Provisional application No. 62/881,900, filed on Aug. 1, 2019.

(51) Int. Cl. G06F 16/835; G06F 16/2453; G06F 16/84; G06F 8/30; H04L 29/08

(52) U.S. Cl. CPC G06F 16/8358; G06F 16/24542; H04L 67/02; G06F 8/30; G06F 16/86

(57) ABSTRACT

In various embodiments, a process for dynamic endpoint generation includes using a stored endpoint definition expressed in a declarative language to dynamically generate an endpoint comprising a representational state transfer (REST) interface. The process includes providing access to a locally-stored database via the endpoint and REST interface.

### CROSS REFERENCE TO OTHER APPLICATIONS

This application claims priority to U.S. Provisional Patent Application No. 62/881,900 entitled DYNAMIC ENDPOINT GENERATION filed Aug. 1, 2019 which is incorporated herein by reference for all purposes.

### BACKGROUND OF THE INVENTION

Distributed computer applications are typically embodied as a multiplicity of computers providing well-defined application program interfaces (APIs) to networked users. Each available API configuration is called an “endpoint,” and each instance of an endpoint on the network is called an “endpoint instance.” Conventionally, endpoints are implemented with imperative programming languages that express how to perform a task, which can be inflexible. Also, endpoints are typically accessed via an API interface to an application server, which in turn communicates with a database server, which can be slow.

### BRIEF DESCRIPTION OF THE DRAWINGS

Various embodiments of the invention are disclosed in the following detailed description and the accompanying drawings.

FIG. 1 is a flow chart illustrating an embodiment of a process for dynamically generating an endpoint and providing access to data using the dynamically generated endpoint.

FIG. 2 is a block diagram illustrating an embodiment of a system for dynamic endpoint generation.

FIG. 3 is a block diagram illustrating an embodiment of a system that dynamically generates, deploys, and manages an API endpoint.

FIG. 4 is a flow chart illustrating an embodiment of a process for declarative API request execution.

FIG. 5 is a flow chart illustrating an embodiment of process for dynamically generating an endpoint comprising a representational state transfer (REST) interface.

FIG. 6 is a flow chart illustrating an embodiment of process for defining a declarative endpoint.

FIG. 7 is a flow chart illustrating an embodiment of process for deploying a declarative endpoint.

FIG. 8 shows an example of processing REST actions in the context of a system that dynamically generates endpoints.

FIG. 9 shows an example of a request and response between a requestor and an endpoint instance without a relay instance.

FIG. 10 shows an example of a relayed request and response.

FIG. 11 shows an example of a sequence of executions and relays.

FIG. 12 shows an example of a direct asynchronous response.

FIG. 13 shows an example of a deferred asynchronous response. First, the requestor initiates a request to Instance A.

FIG. 14 shows an example of a distributed asynchronous response.

FIG. 15 is block diagram illustrating an embodiment of a system for optimized data access.

FIG. 16 is a block diagram illustrating an embodiment of a distributed access environment comprising two or more systems.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In various embodiments, an API as disclosed herein comprises a multiplicity of endpoints expressed in the same declarative language in which data structure and data access is expressed, operated in the same program and program execution as is an associated database, and protected by the same security specifications and protections as is an associated database. The dynamic endpoint generation techniques disclosed herein can be performed by a database that dynamically provides a REST interface at runtime. The REST interface is declarative in nature and thus allows the endpoint to adapt to changes at runtime. REST interfaces can be built directly into a database server. In other words, REST interfaces do not need to be implemented by generating programs from the specifications and then deploying them. The disclosed techniques support high performance rich filtering of data.

The data access node can be an edge server or an origin server. In various embodiments, API endpoints can be placed on specific edge servers based on dynamically sampled network characteristics. Those characteristics also help shape data placement on edge servers, and may change the query plans as well due to changes in data placement. Having all of the information available to the system makes the approach disclosed herein a simpler, and therefore a manageable and more automatic process. Implementing the endpoint on an edge server allows the interface to be tailored to the specific needs of that edge server. No restart or redeployment is needed. The endpoint is implemented by distributing a specification (and not necessarily an implementation). The code of the endpoint can be integral with other code of the application and distributed to a client/requestor. Since the endpoint can be implemented by a database server (and not an intermediate application server), network hops are reduced and processing time is decreased.

Imperative languages such as such as C, Python, or Go, express how to perform a task. By contrast, declarative languages describe a desired outcome, with the program being responsible for figuring out how to achieve the desired outcome. SQL is such a declarative language, forming the basis for most database implementations and installations. SQL allows the physical organization and representation of data to be abstracted from its logical organization and representation. Additionally, SQL database systems are implemented on a wide variety of hardware, supporting portability of SQL applications by abstracting the underlying implementation details of the database server itself.

Many APIs are simple “wrappers” around data stored in databases. The APIs provide the ability to create, read, update, and delete data in the database. Although the process of authoring such interfaces and then implementing them has become more automated over time, conventional techniques continue to be rather time consuming and fraught with problems. Example problems include:
The implementations of the API are expressed using imperative programming languages, which often lack the means to express important relationships such as referential integrity constraints, and other metadata in ways readily usable by other software tools. Referential integrity refers to maintaining accuracy and consistency of data within a relationship.
The implementation of services using compiled, imperative programming languages usually tightly binds the code in the program to the structure of the data in the database. This binding requires a recompilation of the program to adjust to changes, and a redeployment of the program before the updated API is accessible in production. Deployments to production directly affect business uptime, and any errors in the implementation can extend expensive downtime periods.
This tight coupling between application server and database structure requires their deployments to be carefully coordinated. Such coordination can become very complicated in the “fault-guaranteed” environment of the Internet and large server clouds.
A natural mismatch exists between the primary data structures of most modern programming languages and those of SQL. API implementations often spend much of their time reformatting and restructuring data exchanged with databases, performing primitive type conversions and similar operations, only to find that another layer of reformatting and restructuring is needed to meet the API response specifications. These restructurings are usually computationally expensive compared to SQL operations.
SQL operations are based on the manipulation of sets, whereas most programming languages operate on the individual members of a set. A common example of this mismatch is called the “N+1” problem, where instead of using SQL to operate on N records, an initial query gets a list of the primary keys for the records, then operates on each one in a separate query. Instead of a single query, the undesirable result is N+1 queries.
In the same vein, programmers often resort to reading an entire table into their program, then performing searches and changes on those local records. This is even more wasteful than N+1 queries.

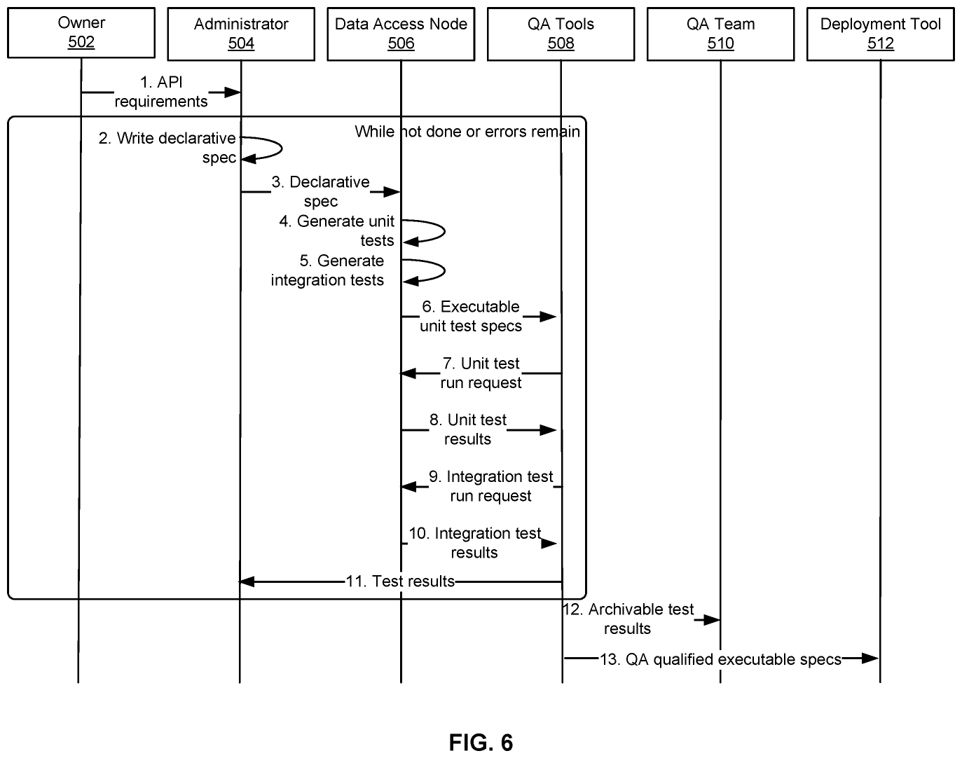

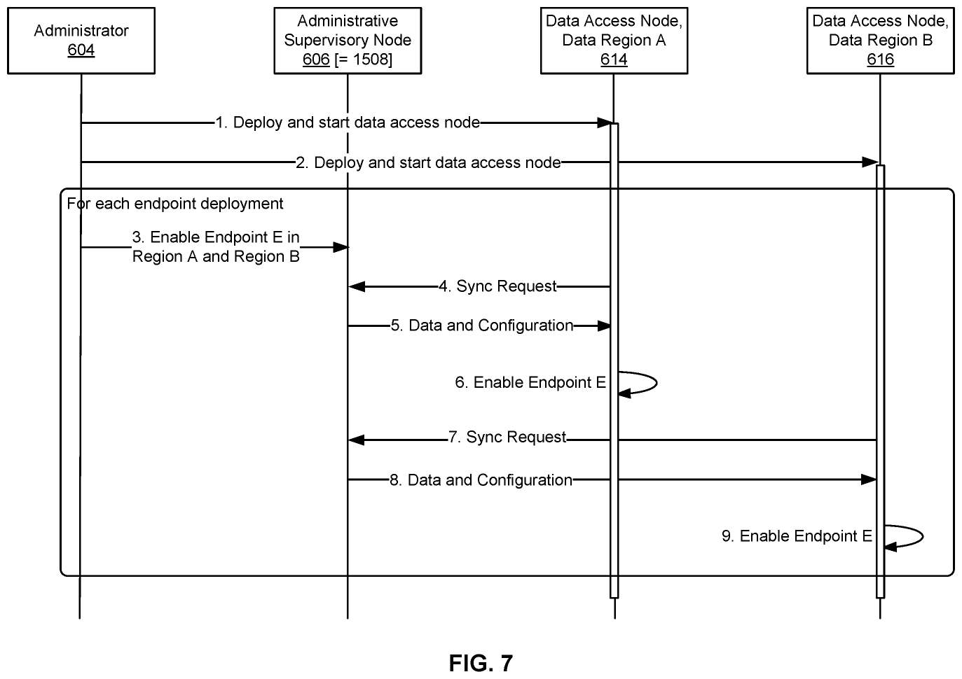

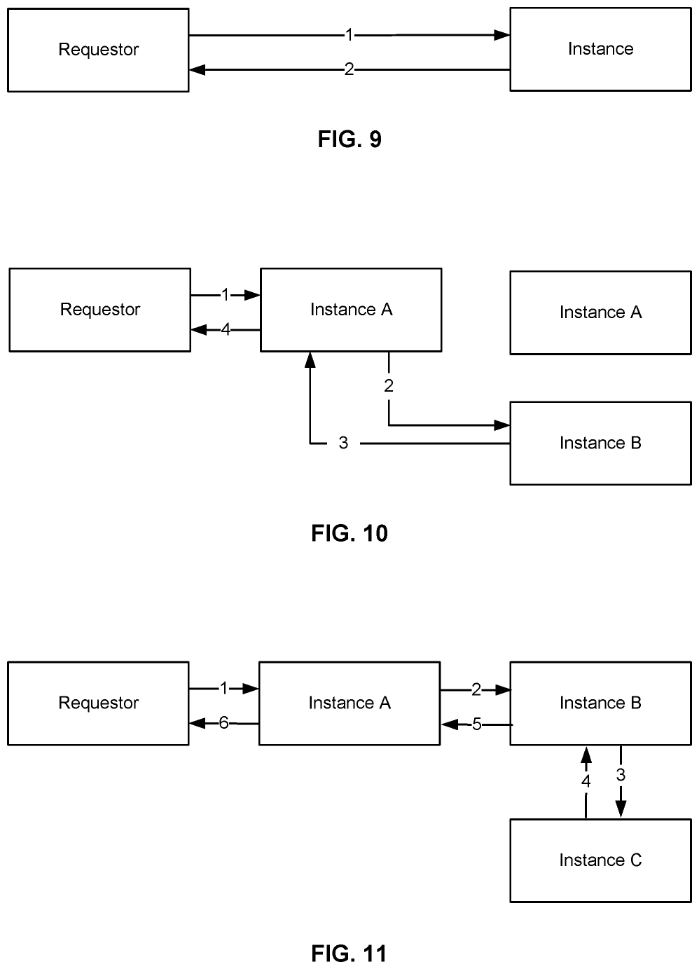

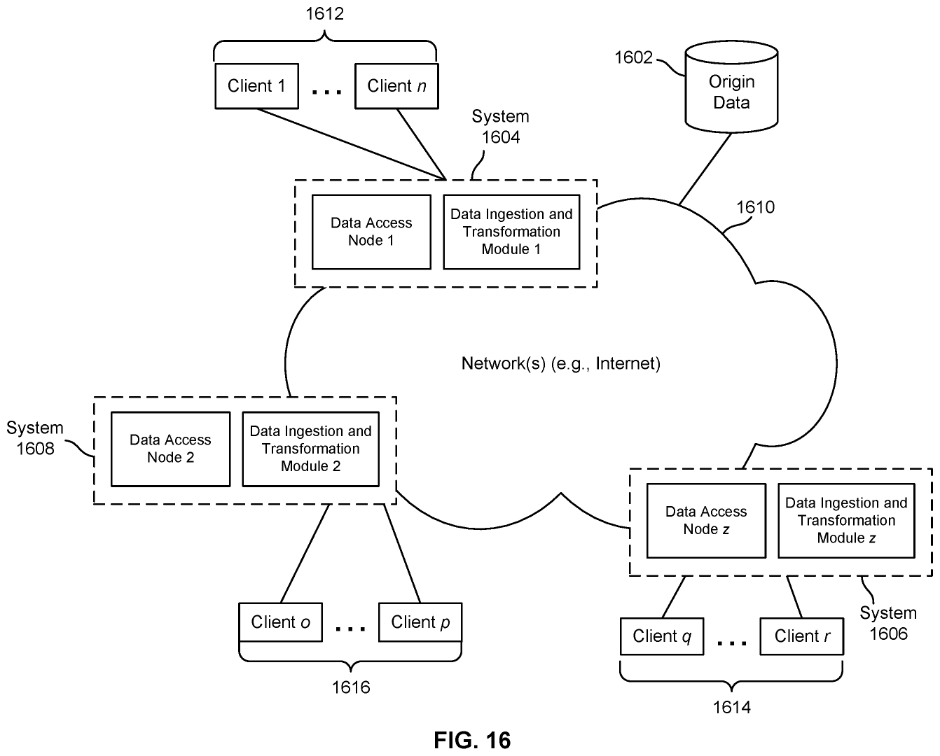

The declarative expression of endpoints and execution of endpoint instances offers many advantages over compiled imperative language implementations, including in various embodiments one or more of the following:
Interpreted APIs eliminate the need for recompilation and redeployment of application software when changing and deploying API definitions, reducing complexity and increasing application availability. FIG. 6 shows an example of defining an endpoint.
The disclosed techniques do not require a server to be restarted to host new endpoint instances. Instead, new endpoint instances can be hosted after initial loading and subsequent reloading of an endpoint specification, thus potentially eliminating downtime for service deployments. FIG. 7 shows an example of deploying an endpoint.
Endpoints can be declaratively specified in the style of REST-based standards (representational state transfer) and/or XML-RPC-based standards (remote procedure call protocol using XML to encode calls and HTTP as a transport mechanism), which provides immediate access to a wide variety of extant software tools.
In various embodiments, an endpoint specification includes an endpoint “target,” expressed as an identity or a noun, and any of a list of parametric verbs specifying “actions” to be taken in the context of the target.
Each action is associated with a “parametric query,” whose arguments are either part of the context of the service request, part of any data available in a “session” context, part of any data available within a transaction's context, and any “global” data available within the server in which the query runs.
In various embodiments, the availability of an endpoint, the availability to the endpoint of data from any and all contexts, and all operational characteristics of the endpoints or their instances, are constrained by the security “authorization components” of the database, having been extended to support endpoints and endpoint instances.
The disclosed techniques provide means to delegate most any request to a different target, permitting both relaying of requests to other servers and aliasing specific requests to other actions. By doing so, service access can be consolidated, enhancing portability and scalability of service access. FIGS. 9-11 show examples of relaying.
The availability of services on instances are based on configuration settings that include but are not limited to manual operation settings and/or model-based settings. Model-based settings include but are not limited to rule-based models and settings, machine-learning models and settings, and algebraic models and settings. FIG. 16 shows an example of an environment with multiple systems.

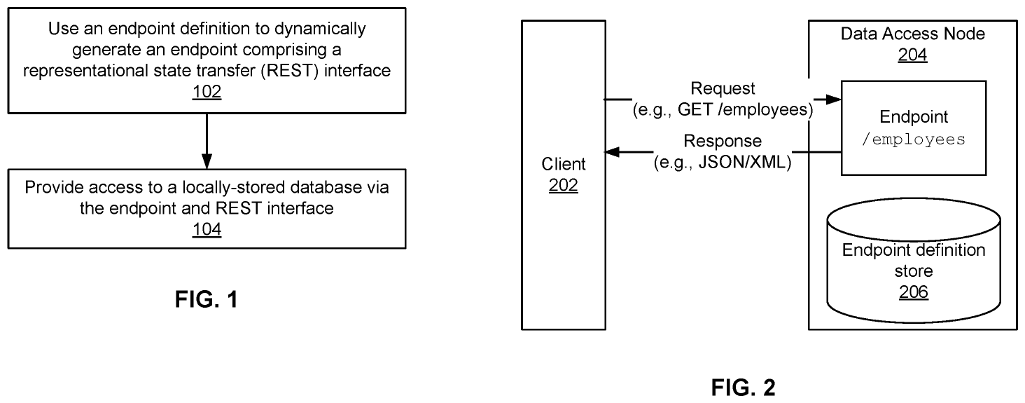

FIG. 1 is a flow chart illustrating an embodiment of a process for dynamically generating an endpoint and providing access to data using the dynamically generated endpoint. This process may be implemented by a system such as the data access node shown in FIG. 2.

In the example shown, the process begins by using an endpoint definition to dynamically generate an endpoint comprising a representational state transfer (REST) interface (100). Dynamically generating the endpoint includes dynamically deriving a REST specification and dynamically implementing the specification in a database without needing external (to the execution) procedural code. The endpoint comprising a REST interface means that the endpoint embodies or manifests the REST interface.

The endpoint definition can be entirely in a declarative programming language such as SQL. The endpoint definition identifies what data gets exposed by an endpoint such as data in a table or view. An example endpoint definition is the SQL statement CREATE REST INTERFACE ON TABLE.

The process provides access to a locally-stored database via the endpoint and REST interface (102). In various embodiments, the process deploys the dynamically generated endpoint to data access node instances (e.g., database servers) and/or clients. Clients can then use the dynamically generated endpoints to access desired data. The process may also generate or implement security policies by attaching a policy object to the endpoint as further described below.

Data accessed using the dynamically generated endpoint can be built off of a first class object such as a query object or off of views (not necessarily tables themselves). For example, the data can be stored across several tables or the tables have overlapping information. Data can be optimized by being combined to form a compound object.

The following figure shows an example of a system in which a dynamically generated endpoint is used to access data.

FIG. 2 is a block diagram illustrating an embodiment of a system for dynamic endpoint generation. The system includes a client 202, data access node 204, and end point store 206.

Client 202 is configured to access data associated with (e.g., stored in) data access node via an API interface. An example of a client is a browser that accesses an endpoint (URL). In this example, client 202 uses an endpoint dynamically generated by data access node 204 to access endpoint “/employees”.

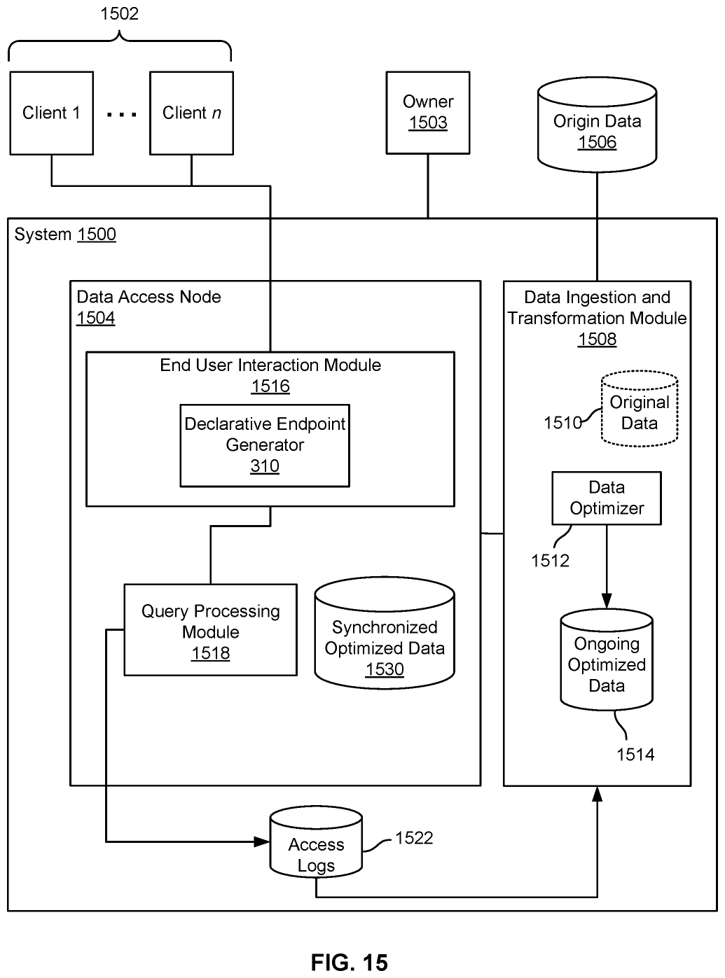

Data access node 204 responds to a client request for data by returning a response such as a JSON or XML object. Conventionally, REST interfaces are understood by an application server and not a database server, so client 202 would interact with an application server rather than directly with data access node 204. Because endpoints dynamically generated according to the disclosed techniques are understood by databases, the client can communicate directly with a database such as data access node 204 via an API interface. An example of a data access node within an environment is shown in FIG. 15.

Endpoint definition store 206 is configured to store a specification of an endpoint written in a declarative language. As further described below, the endpoint definition can be written by an administrator. Conventionally, endpoints are imperative in nature and/or are not dynamically generated. Thus, if the structure of data changes, then an endpoint will not work anymore. By contrast, endpoints are dynamically generated based on structure of data according to the disclosed techniques so they easily adapt to changes in the way data is stored or other changes to the data in the data access node 204. An endpoint definition store can be provided at each data access node. Referring briefly to FIG. 16, each data access node may have a corresponding endpoint definition store. The endpoint definition store may help implement a security policy by distributing (or not distributing) information from a data ingestion and transformation module according to security/access permissions.

In one aspect, declarative expression of endpoint definitions enables many different possible endpoint instance implementations with reduced (minimal) effort compared to conventional deployments. For example, an endpoint might be interpreted as text, converted to bytecodes then interpreted, converted to machine language, and run within the same process as a query executor.

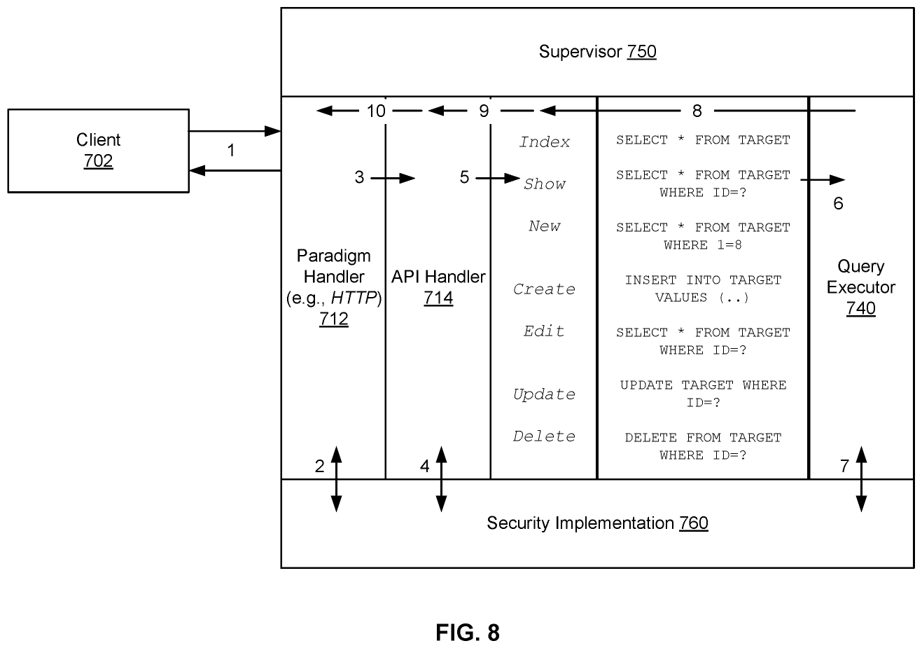

In another aspect, the disclosed techniques define APIs using the same declarative language in which data structures and computations are expressed for query processing. This reduces learning curves and minimizes unnecessary data type and structure conversions typically needed between imperative languages and SQL. FIG. 8 shows examples of declarative expressions of API interfaces.

In operation, client 202 makes a request for an endpoint via an API interface (a REST interface in this example). In this example, the request “GET/employees” identifies an HTTP method “Get” for a URL name (slug), which is “employees.” A key can be specified in the URL. For example, a request for “/employees/12” has ID “12” which would be used as the ID in a SELECT statement such as SELECT * from TARGET where ID=12 and the query executor 740 is the endpoint as shown in FIG. 7.

The endpoint is dynamically generated at runtime using the disclosed techniques and is declarative in nature. In various embodiments, a query object or other representation (previously mapped) is already available. A query object or other representation may be stored persistently such as across database statement (e.g., SQL statement) invocations or executions. The query object or other representation may include and/or be associated with persistently stored information that is or may be used to process a subsequently received query determined to be associated with the query object. In some embodiments, the query object may include or be associated with an optimized plan to process a query associated with the query object. In various embodiments, a template is available to dynamically generate the endpoint as further described with respect to FIG. 8.

Unlike conventional techniques, in one aspect, recompilation is not required and/or the endpoint is dynamically activated meaning that it is not necessary for the REST interface to be generated. In another aspect, the endpoint is dynamically generated by a database server (data access node) and not an intermediate server. This “two-tier” system is faster than a “three-tier” system as further described below.

For example, data access node 204 generates data and configuration information associated with endpoint/employees and sends the information to client 202 so that the client can access the endpoint. The endpoint is compatible with (understood by) a database (here included in data access node 204). The data access node retrieves the appropriate data and responds by providing the requested information, here as a JSON or XML object. The dynamically generated endpoint is generated by the data access node 204 and can be stored in endpoint store 206 for future use by client 202 or other clients.

The data for endpoint “/employees” can be stored in one or more tables in databases that is a collection of values for making up employees information. An endpoint can have one or more interfaces. The database can publish one or more endpoints, and each endpoint can have one or more interfaces. For example, one endpoint is open to the general public and another endpoint for administrative (internal) use.

The following figure shows an example of components within data access node 204 that generate an endpoint.

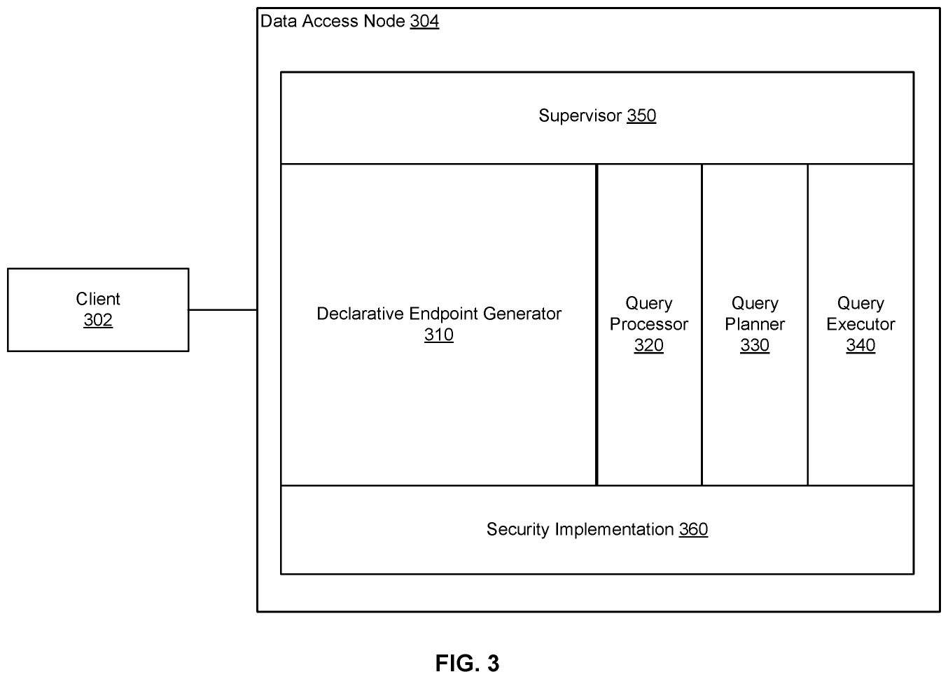

FIG. 3 is a block diagram illustrating an embodiment of a system that dynamically generates, deploys, and manages an API endpoint. The system includes a declarative API endpoint generator 310, query processor 320, query planer 330, query executor 340, supervisor 350, and security implementation 360. In various embodiments, the system is a database augmented with a declarative endpoint generator, which is an API support component.

Query processor 320, planner 330, and executor 340 are configured to process a query made by client (requestor) 302 by planning execution of the query and executing according to the plan to retrieve data from a database responsive to a query. For example, the query parser converts a query to intermediate form, the planner converts the intermediate form into an executable plan, and the executor executes the query plan. The query processor, planner, and executor can be implemented according to continuous query optimization or known techniques in various embodiments. The client 302 (which can be remote) sends requests to a server module, and may be a client such as client 202 of FIG. 2.

Declarative endpoint generator 310 is configured to implement an API using declarative specification and thereby dynamically generate an API endpoint. In various embodiments, the declarative endpoint generator is configured to handle a variety of paradigms (e.g., HTTP), APIs, and perform REST mapping. The declarative endpoint generator is configured to perform the functions of the paradigm handler, API handler, and REST mapper of the following figures. For example, the declarative endpoint generator manages requests and responses for various network transports (UDP, TCP, HTTP, etc.) and interaction methods (synchronous, asynchronous, piggybacked, etc.). The declarative endpoint generator publishes APIs on select paradigms, including but not limited to REST serviced by synchronous HTTP. The declarative endpoint generator maps REST requests to specific SQL queries, optionally using paradigm and API information. This permits the execution of REST interfaces inside the database server, based on a specification expressed in modified SQL.

Supervisor 350 is configured to provide management of control and data flow requests through declarative endpoint generator 310, query processor 320, query planner 330, and query executor 340.

Where required, in some embodiments, endpoints can be automatically implemented as compiled code as opposed to interpreted code. Few if any APIs will need to be compiled and reloaded, but where required, can be simply implemented within the disclosed modular architecture.

In some alternative embodiments, techniques disclosed herein are extended to instances configured with only a subset of the components described above. For example, in some embodiments, data resources may be situated remotely, accessible through APIs termed a “relay” instance. Requests are still be expressed declaratively, with the implementation of the specifications spread across multiple instances. Examples of relay instances are shown in FIGS. 9-11.

Security implementation 360 is configured to implement security policies. APIs and databases share the need to constrain access based on any or all controls implemented by the server. The disclosed techniques provide extensions to the authentication, authorization, and access control functionality of the database server. Thus, the same framework covers the security configurations for both APIs and data resources. This minimizes and (in some cases) eliminates security policy coherence issues where two or more subsystems do not implement the same policies upon which secure system operation relies. Examples of security implementations are further described below.

The following figure shows the flow of control through the system for a typical read access.

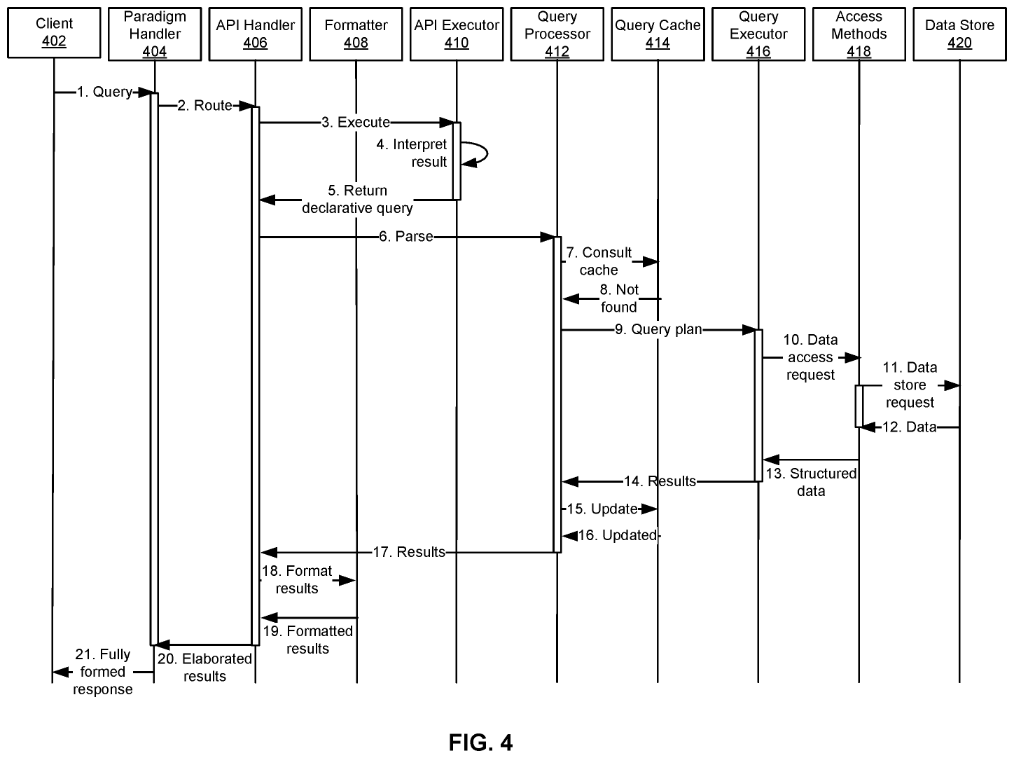

FIG. 4 is a flow chart illustrating an embodiment of a process for declarative API request execution. This process can be performed as part of another process such as 104 of FIG. 1. The process also shows various modules/services that execute various steps but this is not intended to be limiting and some portions of the process may be executed by other modules. For example, a declarative endpoint generator such as 310 of FIG. 3 performs the functions associated with paradigm handler 404 and API handler 406 in various embodiments. In this diagram, the vertical blocks indicate the lifetime of a corresponding step. For example, the duration of a query (1) extends through step 20 when elaborated results are returned.

The numbered paragraphs below correspond to numbered arrows in FIG. 4:
1. Client 402 (an example is client 202) sends a request to Paradigm Handler 404 as HTTP.
2. Paradigm Handler 404 unpacks the request and sends it to API Handler 406.
3. API Handler 406 accepts the request, examines the contents, and sends it to the proper API Executor 410.
4. API Executor 410 determines whether (that) the request is a proper declarative query.
5. API Executor 410 returns the query to API Handler 406.
6. API Handler 406 sends the query to Query Processor 412.
7. Query Processor 412 examines a cache to see if cached plans or results are available.
8. In this example scenario, the cache signals that no cached results are found. Query Processor 412 sends the query to a query planner and gets back a plan (not shown).
9. Query Processor 412 sends the query plan to Query Executor 416.
10. Query Executor 416 sends high-level directives (e.g., Create/Read/Update/Delete) to Access Methods 418.
11. Access Methods 418 execute high-level directives against an associated Data Store 420.
12. Data Store 420 returns data.
13. Access Methods 418 structure data as requested by Query Executor 416.
14. Query Processor 412 receives structured results from Query Executor 416.
15. Query Processor 412 updates Query Cache 414 to include this query.
16. Query Cache 414 acknowledges caching.
17. Query Processor 412 returns results to API Handler 406.
18. API Handler 406 selects a formatter 408 corresponding to the format requested by Paradigm Handler 404.
19. Formatter 408 returns properly formatted results.
20. API Handler 406 returns formatted results to Paradigm Handler 404.
21. Paradigm Handler 404 returns formatted results to Client 402.

The following figure shows an example of how an endpoint comprising a REST interface is generated using an endpoint definition and is an example of 102 of FIG. 1

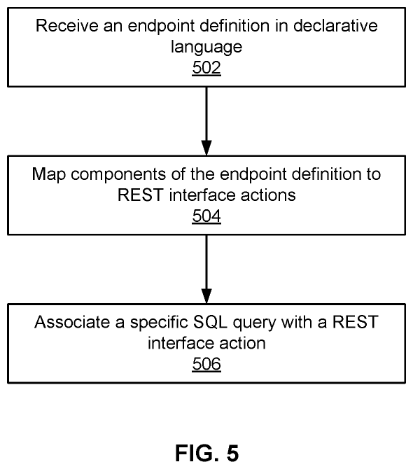

FIG. 5 is a flow chart illustrating an embodiment of process for dynamically generating an endpoint comprising a representational state transfer (REST) interface. The process can be performed as part of another process such as 102 of FIG. 1. The process can be performed by a processor including one inside a database server such as data access node 204.

The process begins by receiving an endpoint definition in declarative language (502). The endpoint definition can be written by an administrator (for example) in a language such as SQL. The endpoint definition can be entirely specified in a declarative programming language.

The process maps components of the endpoint definition to REST interface actions (504). Mapping is a translation function that selects one or more REST actions for one or more SQL actions in the endpoint definition. The process maps components (elements of a SQL statement for example) to REST interface actions. A SQL statement may include elements such as keywords, identifiers, and predicates. In various embodiments, a lookup table is used to find a REST interface action corresponding to a SQL keyword. As further described with respect to FIG. 8, example REST actions Index, Show, New, Create, Edit, Update, and Delete have corresponding SQL statements. The correspondence can be stored in a lookup table. In various embodiments, REST operations with no corresponding SQL associations are managed independently as further described below.

The process associates a specific SQL query with a REST interface action (506). Upon finding corresponding REST interface actions for components of the endpoint definition, the process forms an association between a specific SQL query with a REST interface action. By finding the REST interface action, an endpoint is generated for the endpoint definition that was specified in a declarative programming language. The generated endpoint can then be used to access desired resources. A more detailed example of this process is further described with respect to FIG. 8.

Before describing a declarative endpoint, a conventional endpoint developed and deployed using imperative programming will be described. An endpoint is conventionally developed as follows. A product owner defines API requirements and gives the requirements to a programming team to implement. The programming team writes imperative programs, which are tested using unit tests that test an individual module (e.g., unit or block of source code). A compiler compiles the unit tests and uses quality assurance tools to run the unit test programs. The QA tools report back unit test results to the programming team for the programming team to determine whether API requirements are met. The steps of writing imperative programs and writing/running unit tests can be repeated while errors remain or API requirements are unmet.

Concurrent with or after development of the imperative programs, a quality assurance team writes integration tests to check if different modules are functioning as intended together. The integration tests are written using imperative languages, and similar to unit tests, are compiled using a compiler that compiles the integration tests and runs the integration test programs using the QA tools. The QA tools report back integration test results to the programming team for the programming team to determine whether API requirements are met. The steps of writing and running integration tests can be repeated while errors remain or API requirements are unmet.

Upon completion of unit testing and integration testing, the program source code is considered QA qualified, so the programming team provides the QA qualified program source code to the compiler. The compiler compiles this program source code into executable programs that are then provided to a deployment tool.

An endpoint is conventionally deployed as follows. A source code control system provides executable code and other deployment related files to a container manager. The container manager creates containers corresponding to the executable code. When an administrator sends a deployment request a deployment tool, the container manager provides to the deployment tool containers corresponding to executable code responsive to the deployment request.

The deployment tool proceeds to shutdown existing services by sending a request to do so to one or more data centers. The deployment tool provides containers to the data center(s) and instructs the data center(s) to start new services. Thereafter, the deployment tool sends a deployment status notification to the administrator about the status (e.g., success/failure and other characteristics) of the deployment.

The declarative programming techniques disclosed herein can be used to develop and deploy an endpoint in a simpler way compared with using imperative programming. Unit and integration tests can be generated automatically unlike imperative programming. In some embodiments, as in the example shown in FIG. 5, the system is able to generate at least basic unit and integration tests automatically because the system has both the data and the interface specifications available. Manual test writing and testing may be conducted as well, in some embodiments. This process also reduces the burden on the QA team, requiring less of their attention, thus lowering QA costs per deployment.

The declarative programming techniques disclosed herein can be used to develop and deploy an endpoint in a simpler way compared with using imperative programming. The following figure shows an example of endpoint development and deployment using declarative programming.

FIG. 6 is a flow chart illustrating an embodiment of process for defining a declarative endpoint. The example endpoints are for unit and integration testing but these is merely exemplary and not intended to be limiting as endpoints can perform a variety of functions not limited to testing. The process also shows various modules that execute various steps but this is not intended to be limiting and some portions of the process may be executed by other modules as described with respect FIG. 4.

The numbered paragraphs below correspond to numbered arrows in FIG. 5:
1. Owner 502 (such as a data owner or online merchant) defines API requirements and sends them to an administrator 504 such as DevOps administrator.
2. Administrator 504 writes a specification of an endpoint in a declarative programming language (also called an endpoint definition).
3. Administrator 504 sends the declarative specification to a processor such as data access node 506 (an example is data access node 204 of FIG. 2). In this example, the declarative specification defines testing to be performed. Thereafter, unit and integration tests can be automatically generated by the data access node as follows. In various embodiments, the data access node 506 generates a universal API documentation specification of the endpoint (e.g., Swagger).
4. Data access node 506 generates unit tests. The unit test is a model based on the endpoint definition written by the administrator. For example, the endpoint definition may specify various entities to perform tasks to carry out a test. A unit test can check things like whether an update works, whether an index works, and the like.
5. Data access node 506 generates integration tests. Similarly, the integration test is a model based on the endpoint definition written by the administrator.
6. Data access node 506 sends the unit test specs to QA Tools 508. A QA tool can be included in a continuous integration system, and uses the unit test specs to determine how a test can be run on a particular system.
7. QA Tools 508 sends a unit test run request to data access node 506. A test run request defines how the test can be run on a particular system.
8. Data access node 506 sends unit test results to QA Tools 508.
9. QA Tools 508 sends an integration test run request to data access node 506.
10. Data access node 506 sends integration test results to QA Tools 508.
11. QA Tools 508 sends test results to Administrator 504. At this point, an endpoint has been defined (a specification has been created), implemented (code interpretation), deployed on test servers, and confirmed to function as intended. In various embodiments, steps 2-11 are repeated while errors remain or some other stop condition is unmet. As further described with respect to FIG. 15, test servers can be located on the edge or elsewhere, depending on the purposes of the test. Typically, unit test servers can run anywhere while staging test servers typically run in the same regions as production such as at the edge.
12. QA Tools 508 sends archivable test results to a QA Team 510.
13. QA Tools 508 sends QA qualified executable specs to a deployment tool 512.

FIG. 7 is a flow chart illustrating an embodiment of process for deploying a declarative endpoint. The process also shows various modules that execute various steps but this is not intended to be limiting and some portions of the process may be executed by other modules as described with respect FIG. 4.

In this example, endpoints are already defined and tested. In this diagram, the vertical blocks indicate the lifetime of a corresponding step. For example, the duration of a data access node corresponding to Data Region A extends until after all endpoints have been deployed and enabled. This example shows two data regions but this is merely exemplary and not intended to be limiting. The term “region” includes but is not limited to locations delimited by geographical region, nation boundaries, states, provinces, cities, or similar, as well as logical differences such as computing regions, data centers, specific racks within data centers, or similar. The numbered paragraphs below correspond to numbered arrows in FIG. 6:
1. Administrator 604 deploys and starts a data access node associated with a first data region A (which may include one or more data centers). In various embodiments, a data access node can be deployed according to known techniques or can already be deployed.
2. Administrator 604 deploys and starts a data access node associated with a second data region B.
3. Administrative supervisory node 606 enables an endpoint E in Region A and Region B. An example of the administrative supervisory node is data ingestion and transformation module 1508 shown in FIG. 15 and data ingestion and transformation modules 1, 2, . . . , and z shown in FIG. 16.
4. Data Region A 614 sends a sync request to master data access node 606.
5. Data access node 606 sends data and configuration information to Data Center A 614. Referring briefly to FIG. 2, the data and configuration information is stored in endpoint store 206.
6. Data Region A 614 uses the received data and confirmation information to enable endpoint E. Similarly, Data Region B can enable endpoint E as follows.
7. Data Region B 616 sends a sync request to master data access node 606.
8. Data access node 606 sends data and configuration information to Data Region B 616.
9. Data Region B 616 uses the received data and confirmation information to enable endpoint E.

The following figure shows some examples of REST actions that can be handled using endpoints generated according to the disclosed techniques.

FIG. 8 shows an example of processing REST actions in the context of a system that dynamically generates endpoints. Each of the components are like their counterparts in FIG. 3. Paradigm Handler 712 and API Handler 714 may be included in a declarative endpoint generator such as 310 of FIG. 3.

Example REST actions are shown (Index, Show, New, Create, Edit, Update, and Delete) next to their corresponding SQL statements. “Index” corresponds to selecting everything from a target. “Show” corresponding to selecting everything from a target where an ID matches an ID specified by the show action. “New” generates a new record (template or framework) and corresponds to selecting everything from a target where a condition can never be satisfied (1=8 in this example). The non-satisfiable condition has the effect of returning an empty framework (template). “Create” performs an insert or provided values. “Edit” returns a particular record in an easily manipulated format such as HTML (the format can be defined using the endpoint), and is often used in forms. “Update” updates a specified record. “Delete” removes a specified record.

The target can be a table or a view. A view typically has data stored across several tables. A REST action on a view target can be carried out using SQL updatable view so that updates are stored in a correct table. For example, an “update” action on a view of employees and addresses corresponds to data stored in two tables: one table stores the employee's name and the other table stores the employee's addresses. When a REST action to update an employee record to change an address is processed, the view is updated and the corresponding entries in each of the two tables are updated appropriately to carry out the update.

The numbered paragraphs below correspond to numbered arrows in FIG. 7:
1. Client 702 (an example of which is client 202 of FIG. 2) makes a request using HTTP Request/Response transport paradigm with REST formatting.
2. Paradigm Handler 712 consults Security Implementation 760 to approve the request.
3. Paradigm Handler 712 recognizes that a request is a REST request, and invokes a REST API handler.
4. API Handler 714 consults Security Implementation 760 to ensure compliance. Some examples of ensuring security compliances are further described below.
5. API Handler 714 invokes the REST API associated with the target and request.

The REST API maps the request to a “verb,” along with parameters derived from the request's arguments and context settings, executing that query.
6. Query Executor 740 validates the request with the Security Implementation. Some examples of security validation are further described below.
7. The query is executed, and a response is passed back through the call chain, decorated when necessary by the REST controller.
8. A response is passed back through the call chain, modified as needed by API Handler 714.
9. A response is passed back through the call chain, decorated, and/or repackaged as needed for transmission via the selected paradigm.
10. The packaged response is delivered to Client 702.

In various embodiments, the techniques disclosed herein include a security implementation that meets at least a portion of a standard such as cross-original resource sharing (CORS). The declarative nature of endpoint generation enables security policies to be implemented dynamically by a data access node or similar entity that generates the endpoint. A security policy can be expressed as a policy object attached to an endpoint. A security framework and policies center around one or more of the following categories/practices, which collectively comprise a security implementation (such as the security implementation shown in FIGS. 3 and 7:
Identity
Authentication
Authorization
Access Control
Auditing
Encryption
Privacy

Security compliance can be determined by measuring the extent to which the example factors listed above have been suitably specified and whether those specifications have been met. Some examples of security practices implemented by REST include authorization (including protecting HTTP methods, whitelisting allowable methods, and protecting privileged actions and sensitive resource collections), securing output (including using proper JSON or XML serializers), and using correct HTTP codes (including using 401 and 403 correctly). Other aspects of security can be implemented by a data access node or by SQL.

To summarize, Table 1 shows a security recommendation implemented by the corresponding marked actor.

TABLE 1

| | | | |
|---|---|---|---|
| | Implemented | | |
| | by Data | Implemented | Implemented |
| Security Practice | Access Node | by SQL | by REST |

Authorization

| | | |
|---|---|---|
| Protect HTTP methods dynamically | | X |
| Whitelist allowable methods | | X |
| Protect privileged actions and sensitive | | X |
| resource collections | | |
| Protect against cross-site request forgery | X | |

Validate Input

| | |
|---|---|
| Validate URLs | X |
| Validate incoming content-types | X |
| Validate response types | X |
| Validate input encodings | X |

Secure Output

| | | | |
|---|---|---|---|
| Send proper security headers | X | | |
| Use proper JSON or XML serializers (depends | X | X | X |
| upon internal source of JSON) | | | |

Carefully manage encryption

| | | |
|---|---|---|
| Protect data in transit (e.g., HTTPS always | X | |
| used) | | |
| Protect data at rest (function of database and | | X |
| SQL processing) | | |
| Ensure message integrity (e.g., confirming | X | |
| message signatures) | | |

Use correct HTTP codes

| | | |
|---|---|---|
| Use 401 and 403 correctly (what implements | X | X |
| this may be context-dependent) | | |

In REST implementations, REST actions correspond to HTTP methods. Each URL identifies the resource upon which to operate, and the HTTP method further defines the desired operation. For instance, an HTTP request sent to a REST endpoint is of the form:

HTTP method
scheme
user
password
host
port
slug

The slug hasten of these forms:

/resources to identify all the available resources of type “resource”
/resource/id to identify a specific resource identified using the key “id”

An HTTP GET request applied to a URL with the slug/employees would return a list of all employees available through that endpoint. An HTTP GET request applied to a URL with the slug/employee/27 would return the information regarding employee with id=27. An HTTP POST request applied to a URL with the slug/employee/27 would update the information for employee with id=27. Ensuring that the combination of HTTP method and REST URL makes sense (among other things) help to protect HTTP methods.

The resources available through the REST interface map directly to SQL database entities, specifically tables. Each SQL table is protected by SQL security policies that control the ability to view and change the table. These controls are documented in various SQL standards.

In various embodiments, SQL authorizations are extended directly into the associated REST actions, and then through the associated HTTP-method/URL-format pairings.

CREATE, READ, UPDATE, and DELETE operations on individual table items can be mapped to CREATE, SHOW, UPDATE, and DELETE actions in the generated REST interfaces. The permissions defined for database entity access collectively comprise an entity access policy. In some embodiments, the entity access policy is converted into an equivalent REST access policy. In other embodiments, the REST access policy is determined dynamically by accessing the entity access policy per request. In other embodiments, entity access policy items are cached as REST access policies, loaded from the database entity only when needed.

The REST access policy defines a set of permissions, where each permission associates a slug with a specific SQL access, generally including, but not limited to, SELECT, INSERT, UPDATE and DELETE operations. For instance, an attempt by a particular request to update a database entity via an HTTP POST might fail if the requestor is unidentified or is not in a list of users allowed to access that table.

The REST access policy also defines a set of rules matching HTTP request characteristics with REST actions. As an example, a REST index operation that returns all employees might have a rule that matches the IP range of a request, and permits or denies the request based on whether that remote IP address satisfies some criteria, including but not limited to presenting bona fide credentials.

These tests are independent from general access policies implemented for any request targeting a data access node instance, and may be used independently or in conjunction with more general restrictions. For example, a data access node service might require a valid JWT token, which identifies the requestor and is digitally signed. That request may be allowed or denied based on the veracity of that signature. By defining where requests are allowed to come from, attacks such as cross-citing scripting attacks can be prevented. The REST access policy modifies a more general policy, potentially further restricting access.

The security policy may identify validations of any or all of the values in the request, including the URL, any HTTP payload, HTTP headers, etc. The expression of these validations include validations derived from, and/or implemented by the SQL entity access policies. As an example, an update to a table has a validation requiring some field's value to be a positive integer. That validation may be invoked by the SQL processor when the REST action is invoked, but it may instead be implemented by the REST network handler, using a validation derived from the SQL entity validations. The declarative nature of the disclosed SQL validations makes their conversion straightforward, affording considerable performance advantages.

The use of “proper” JSON and XML serializers means exercising control over the way that data in the database is formatted for transmission to the client to ensure that no compromise of the policies is possible. In various embodiments, serializers do not permit users to define and operate their own serializers in our server code.

Finally, proper HTTP code usage is a systemic concern. The disclosed REST implementation insures that there is sufficient known information to properly choose HTTP codes for all possible REST requests. In various embodiments, collectively, these implementations cover the security approaches to protect REST interfaces as specified in Table 1 above.

SQL privilege models allow the use of roles as well as specific identities as the object of grants. The same generality applies to the disclosed REST model. The initial REST roles are derived from the SQL roles. As SQL roles change, REST roles may or may not be updated as dictated by general policy. As REST roles change, SQL roles may or may not be updated as dictated by general policy. Some associations between REST and SQL roles may be proscribed through a specific or general policy, in which case no derivations occur.

An example of converting a SQL entity access policy to a REST access policy will be explained using a SQL GRANT statement, which is a command to provide access or privileges on database objects to users. The syntax for the GRANT command is: GRANT [privilege name] ON [object name] TO [user name PUBLIC role name] (WITH GRANT OPTION), where “privilege name” is the access right or privilege granted to the user. Example access rights include ALL, EXECUTE, and SELECT. “Object name” is the name of a database object like TABLE, VIEW, STORED PROC, or SEQUENCE. “User name” is the name of the user to whom an access right is being granted. “PUBLIC” is used to grant access rights to all users. “ROLES” are a set of privileges grouped together. “WITH GRANT OPTION” allows a user to grant access rights to other users.

The conversion of SQL entity access rules to REST rules is implemented by examining each GRANT associated with the target SQL entity and mapping the SQL “privilege name” to an associated REST action. For example, SELECT maps INDEX, SHOW, and NEW actions of a REST interface; INSERT maps to a CREATE action; UPDATE maps to an UPDATE action; and DELETE maps to a DELETE action.

The statement “GRANT SELECT ON PRODUCTS TO ALL” allows anyone to access the table PRODUCTS. This translates into permissions for anyone to access the INDEX, SHOW, and NEW actions of a REST interface. The statement “GRANT INSERT ON PRODUCTS TO admin” allows the REST action CREATE to be invoked on the PRODUCTS resource by anyone with the admin role. The statement “GRANT UPDATE ON PRODUCTS TO some role” allows the REST action UPDATE to be invoked on the products resource by anyone with the “some role” role. The statement GRANT DELETE ON PRODUCTS TO some role allows the REST action DELETE to be invoked on the products resource by anyone with the “some role” role.

In various embodiments, REST operations with no corresponding SQL associations are managed independently. For example, the associations are managed independently through applying appropriate specific default rules. REST operations provide to the SQL query extra parameters determined by the context of the request. For instance, the user ID of the person making a request is available. A REST rule can be implemented controlling access by that user to any collection or single table. Furthermore, the SQL entity might be a view, which can include a where clause based on context items. For instance, a view could restrict a SELECT result set to only those rows in the same time zone as the requestor.

The declarative and dynamic nature of the policies allow them to be easily rendered as part of an audit. REST action privileges do not override SQL permissions, maintaining the integrity of the SQL database tables and their contents.

In various embodiments, a relay instance is included in a system. Such an embodiment (with a relay instance) is advantageous for testing, where live data sources may not be available or undesired for any reason. This embodiment is also advantageous for implementations subject to “data sovereignty” restrictions and requirements by allowing the partitioning of data, access to data, and the processing of data to be tailored to the given restrictions. This embodiment maintains without loss of generality the same characteristics possessed by the other embodiments described herein.

First, a standard request response (without a relay) will be described. FIG. 9 shows an example of a request and response between a requestor and an endpoint instance without a relay instance. First, the requestor initiates a request to an endpoint instance (simply called “instance”). Second, the instance executes the request and returns results in response.

Next, a few examples of request response using a relay will be described. FIG. 10 shows an example of a relayed request and response. First, the requestor initiates a request to an instance not knowing if the instance is acting as a relay or not. Second, the instance (which is a relay instance in this example) determines that Instance B should fulfill the request and initiates a request to Instance B. Third, Instance B executes the request and returns results. Fourth, the relay instance returns the results to the requestor.

FIG. 11 shows an example of a sequence of executions and relays. First, the requestor initiates a request R1, which it starts to execute. During execution, Instance A determines that it needs data from Instance B. Second, Instance A initiates a request R2 to Instance B. Third, Instance B determines R2 should be executed on Instance C and relays R2 there. Fourth, Instance C executes the request, returning results to Instance B. Fifth, Instance B returns results to Instance A. Sixth, Instance A returns results to the requestor.

The following figures show some examples of asynchronous responses.

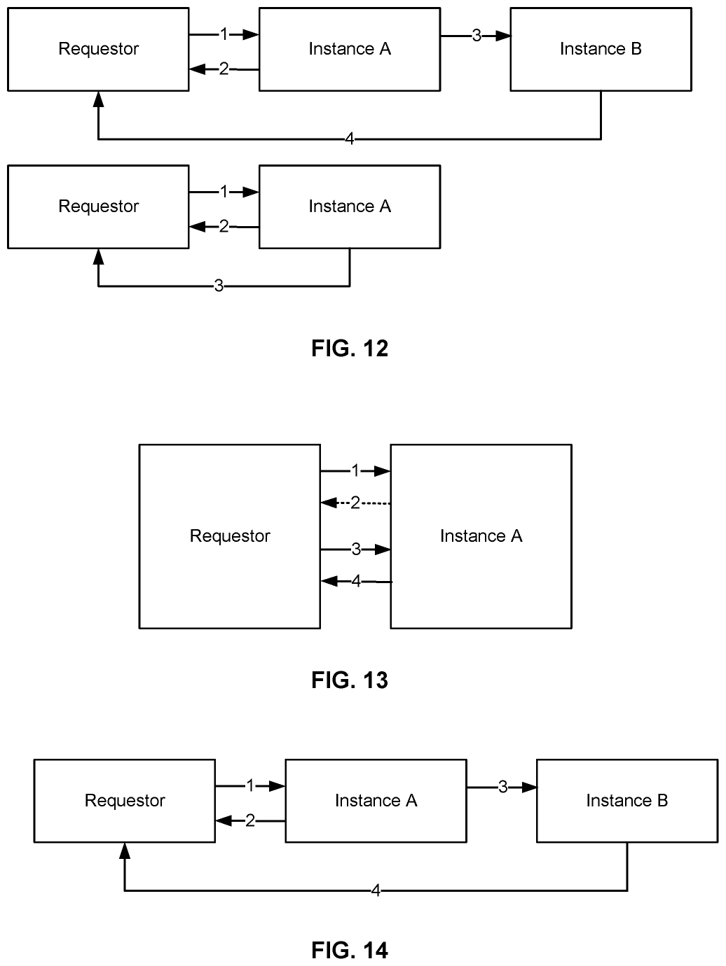

FIG. 12 shows an example of a direct asynchronous response. First, the requestor initiates a request to Instance A. Second, Instance A responds with an acknowledgment containing an execution ID. Third, Instance A sends the results to the requestor.

FIG. 13 shows an example of a deferred asynchronous response. First, the requestor initiates a request to Instance A. Second, Instance A responds with an acknowledgment containing an execution ID. Instance A executes the request at will. Third, the requestor sends another request to Instance A. Fourth, Instance A executes the request, returning results for both requests to the requestor (assuming that Instance A has completed the request). The status of all outstanding requests can be returned with every response

FIG. 14 shows an example of a distributed asynchronous response. First, the requestor initiates a request to Instance A. Second, Instance A responds with an acknowledgment containing an execution ID. Third, Instance A determines the request should be executed on Instance B, and relays the request there. Fourth, Instance B executes the request, delivering results directly to the requestor.

The disclosed techniques typically perform better than traditional three-tier systems in which databases are placed in a tier separate from an application server and a client. The communications costs for such systems are much higher than the disclosed systems. Sometime, a three-tier system may integrate a database and thus become a two-tier system. Examples include SQL databases, noSQL databases, and text databases.

SQL databases can connect directly to clients. However, they are slower than the disclosed systems because they are still full RDBMS databases, with the attending performance issues related to their general purpose nature. In addition, they connect using persistent socket connections, which reduce their scalability. Until recently, browsers were unable to connect to them directly at all, and even now unresolved connectivity issues remain.

NoSQL databases are usually some variant of a key-value system. That is, they are essentially like a SQL database where every table has two fields: key and value. The only select statement they can run is SELECT VALUE WHERE KEY=‘example’. Some NoSQL databases add the capability to characterize data and select only the results that match the characteristics. They can be fast, scale well, and offer many other features. However, access is imperative, not declarative, in that programs are written to get the data out, cross-reference the data, etc. If the data format needs to change, the programs need to be rewritten. SQL writes the programs to do that kind of work for users. If the structure of the data in a database changes, it is normal to rewrite some SQL, but SQL takes care of which indices to use, when and how to sort, understanding the optimal ways to do that. A NoSQL database like Redis is a key-value store optimized for reading and writing data at high speeds. However, such databases do not understand SQL and are therefore unlike the disclosed databases that understand SQL.

Text databases index free text like word-processing documents instead of requiring data in a tabular format. Conventional text databases typically do not have SQL interfaces and so they are also unlike the disclosed databases that understand SQL.

Some Online Analytical Processing (OLAP) databases specialize in OLAP, which is a cross between Online Transaction Processing (OLTP) and Decision Support (analytical) processing. However, these databases deal mostly with “aggregations,” dicing up data in the same way that a pivot table does. They do not provide fast access to the data, do not effectively help end-users filter data on-the fly, and typically do not perform query processing.

Other conventional techniques such as SSG and MAP/REDUCE require a great deal of compute and network resources. In Server Site Generation (SSG) implementation, every possible query that a client might express is executed and the results are stored. As an example, to identify red shoes, SSG precomputes query results for shoes of each color, storing each color separately. As another example, SSG generates individual pages for all their online products, one per product configuration, for all their products, continually (e.g., the pages are updated every few minutes). This leads to the generation of large data sets, which requires a lot of compute and network resources. Also, it is not the data that are stored, but the results of the queries, typically formatted in HTML and ready to return to a user without any further computation. MAP/REDUCE may return text-search results with sub-second response times but requires much more compute power compared with the disclosed techniques.

The data access node configured to dynamically generate an endpoint shown in the previous figures may be included in other systems such as systems for optimized data access. The following figure shows one such example.

FIG. 15 is block diagram illustrating an embodiment of a system for optimized data access. System 1500 includes data access node 1504 and data ingestion and transformation module 1508. Data access node 1504 is configured to communicate with clients 1502 and to generate endpoints for example by performing the disclosed techniques. Data ingestion and transformation module 1508 is configured to communicate with origin database 1506 and optimize data. Data ingestion and transformation module 1508 and data access node 1504 are communicatively coupled, and cooperate to improve clients' user experience by making data more readily accessible among other performance improvements.

For example, data access node 1504 polls data ingestion and transformation module 1508 for new data, which may be different from a previous poll. The new data is stored in ongoing optimized data store 1514. Synchronized optimized data store 1530 stores the new data. This enables data access node 1504 and data ingestion and transformation module 1508 to share information while working independently to perform optimizations, the results of which may be combined in various embodiments.

Data access node 1504 and data ingestion module 1508 may cooperate as follows. Suppose some data from different tables in origin database 1506 are combined into a table in ongoing optimized data store 1514 or vice versa (the table is in synchronized optimized data 1530). A specific index is selected to be used when searching based on information in synchronized optimized data store 1530 and query trends identified by data access node 1504. Data ingestion and transformation module 1508 generates statistics about the data that are useful to data access node 1504 or vice versa. Data ingestion and transformation module 1508 helps to perform part of a useful query optimization such as an expensive SQL JOIN. Then the data access node 1504 creates indexes on the resulting JOIN table.

Data ingestion and transformation module 1508 includes data optimizer 1512, ongoing optimized data store 1514, and optionally a copy of original data 1510. Data ingestion and transformation module 1508 is configured to transform data received from origin database 1506. In various embodiments, the data ingestion and transformation module performs the transformation according to a set of transformations determined by data optimizer 1512.

Data optimizer 1512 may include and/or be implemented by an optimization module, layer, and/or process/function completed by cooperation between data access node 1504 and data ingestion and transformation module 1508. In various embodiments, data optimizer 1512 comprises a machine learning layer configured to determine an optimal set of data structures and indexes to store and provide access to data received from origin database 1506.

Initially, in some embodiments, data may be stored only in its original form (e.g., in store 1510). Over time, data optimizer 1512 determines optimal data transformations, such as storing data from two or more relational tables in a single compound data structure, and/or indexing data differently than it may be indexed at origin database 1506. Referring further to FIG. 15, transformed data from origin database 1506 is stored in ongoing optimized data store 1514. Data optimization may be an ongoing or repeated process that updates the optimized data stored in store 1514.

Data access node 1504 includes end user interaction module 1516, query processing module 1518, synchronized optimized data store 1530, and one or more query-related caches (here query cache 422 and results cache 424). Client 1502 is an example of client 202. Requests (e.g., database queries, application-level requests that require queries to be performed, etc.) from client systems 1502 are received and processed by end user interaction module 1516.

End user interaction module 1516 is configured to perform the techniques disclosed such as the process of FIGS. 1 and 5 to dynamically generate an endpoint from an endpoint definition defined in a declarative language for client 602. End user interaction module 1516 may include application code, user interface code, etc. End user interaction module 1516 may be configured to receive and respond to SQL and/or other queries from clients 1502 and/or implied by and/or otherwise required to be performed to respond to requests received from clients 1502. In various embodiments, end user interaction module 1516 includes a parser and a paradigm API handler for handling queries and a declarative endpoint generator 310. The functions of the parser and/or paradigm API handler may be performed by the declarative endpoint generator as described above.

Queries required to respond to requests from client systems 1502 are processed by query processing module 1518, which includes a dynamic query planner/optimizer 1520 (sometimes simply called a query optimizer). Query planner/optimizer 1520 is an example of planner 508. Query optimizer 1520 may include and/or be implemented by an optimization module, process, and/or layer (not shown). In various embodiments, a query optimizer determines an optimized manner in which to perform a given query. The query optimizer may be configured to apply conventional query optimization techniques in light of what is known about how the data has been stored and indexed in optimized data 1514. The results or other information associated with query processing module 1518 may be stored in one or more stores.

In the example shown, data optimizer 1512 included in data ingestion and transformation module 1508 performs optimization processing to determine the optimal data structure(s) and/or format in which to store and/or index data ingested by data ingestion and transformation module 1508. In various embodiments, the optimization processing is performed offline in batch operations, e.g., using the original data 1510. In other embodiments, a remote optimization service may perform optimization processing.

In various embodiments, access logs 1522 generated by query processing module 1518 and/or received from other, remote data access nodes, are used by optimizer 1512 to determine and/or update optimizations to transform and/or index data received from origin database 1506. Over time, data in origin database 1506 may change, as may the subset of data ingested and stored in local data store 1510, queries received from clients 1502, priorities of the data owner 603, etc. Data received from origin database 1506 is stored in its original, as-received format in original data store 1510. In various embodiments, data optimizer 1512 and/or another optimization module, system, or service uses original data 1510 and data access patterns and/or statistics (e.g., from logs 1522) to determine an updated optimal set and type of data structures and/or indexes to be used to store and provide access to data received from origin database 1506. In some embodiments, the data optimizer 1512 performs optimization processing (e.g., using machine learning, artificial intelligence, and/or other techniques), periodically (e.g., nightly), continuously, or in response to a trigger, until currently optimized to current conditions, etc., in an ongoing effort to improve data access.

While in various embodiments techniques disclosed herein may be implemented on and/or with respect to a system such as system 1500, in various other embodiments techniques disclosed herein may be implemented on one or more systems different in one or more respects from system 1500.

In various embodiments, techniques disclosed herein may be used in an environment and system comprising a distributed set of systems. For example, the system shown in the figures above can be included in (e.g., part of) a larger system that includes several sets of data access nodes and data ingestion and transformation modules as shown in FIG. 16.

FIG. 16 is a block diagram illustrating an embodiment of a distributed access environment comprising two or more systems. In various embodiments, one or more or all of the systems 1604, 1606, and 1608 may be implemented as system 1500 of FIG. 15. For example, each system 1604, 1606, and 1608 includes a data access node and a data ingestion and transformation node. In various embodiments, the environment includes a data ingestion and transformation module shared by the systems and each system includes a data access node corresponding to FIG. 2 and further described with respect to FIG. 15. In various embodiments, the environment includes a data access node shared by the systems and each system includes a data ingestion and transformation module. Clients 1612, 1614, and 1616 may be connected to systems 1604, 1606, and 1608 by one or more networks and/or Internet 1610. Similarly, origin database 1602 may be connected to systems 1604, 1606, and 1608 by one or more networks and/or Internet 1610. One or more data access nodes or one or more data ingestion and transformation modules may be located on the edge, e.g., closer to the clients to decrease response times and reduce bandwidth needed to communicate with associated clients.

Each system, client 1612, and origin database 1602 is like its counterpart described above unless otherwise described herein. In this regard, an origin data source is represented by origin database 1602 but may be implemented by one or more data sources as described with respect to origin databases 1606.

In the example shown, access to data included in origin database 1602 is provided via distributed systems, represented by systems 1604, 1606, and 1608. Systems 1604, 1606, and 1608 may be distributed geographically, logically, or otherwise. Here, systems 1604, 1606, and 1608 are distributed geographically and are shown to be configured to provide access to a local set of clients 1612, 1614, and 1616, respectively.

In various embodiments, each set of clients 1612, 1614, and 1616 may be configured to access data via one or more of associated data access nodes in systems 1604, 1606, and 1608. The clients may access different origin databases. For example, the system accesses data from different databases, optimizes the combined data for access by the clients. The clients may be associated with different and potentially overlapping subsets of data. Application level requests from clients 1612, 1614, and 1616 are routed, e.g., by IP address, application instance identifier, user agent identifier, or otherwise, to corresponding data access nodes 1604, 1606, and 1608, respectively. For example, routing is influenced by location, client type, or the like.

In various embodiments, each system 1604, 1606, and 1608 stores an associated subset of data from origin database 1602. Each may store different data than one or more other of the systems 1604, 1606, and 1608. Each may store data in the same or a different format and/or data structures as other of the systems 1604, 1606, and 1608. For example, a first system may store a set of data in one set of one or more data structures, while a second system may store the same data in a different set of one or more data structures. In various embodiments, the system operates on a production database or copy of the production database, and selects another data structure to organize the subset of data based on a set of queries. Data may be distributed in a variety of ways including by separating data based on target audiences (such as shoes on one server and dresses on another server), geographical location, performance characteristics, or the like.

Examples of performance characteristics include, without limitation, latency of queries or relative value of queries. For example, low-latency queries, demanding the earliest possible responses, are separated from queries without such needs. Low-latency queries benefit from having data organized in ways that match their desired result structure. Transforming origin data to match the query's needs improves throughput and reduces latency. Distributing such transformed data to nodes receiving the most of the aforementioned queries further improves latency for individual queries, and improves throughput for the node as a whole. As an example, a query requesting the price for a stock selected through membership in any of several sector criteria might be considered a low-latency query, whereas the total number of outstanding shares would not be considered as such.

As another example, queries considered to be more valuable, such as those made at a critical juncture in a workflow, are separated from other queries by organizing the data to ensure that the query will complete with reduced latency and the least likelihood of failure. Suppose a valuable query requires accessing all the information concerning a user's e-commerce shopping cart, which the system disclosed herein optimizes by ensuring that all cart data is available to all nodes and is organized to minimize the time needed to implement a successful checkout process. If that query had less value, the data may be organized differently and involve more manipulation within the data nodes. Less valuable queries might take longer than others or potentially receive errors and require resubmission with less detriment to the user experience.

Likewise, in various embodiments, each system may index (the same, partially the same, and/or different) data differently than one or more other systems. For example, indexes or index types are selected based on a predominant query for node such as a database instance.

Each system 1604, 1606, and 1608 may be optimized differently than one or more other systems. For example, each system 1604, 1606, and 1608 may be optimized independently of one or more other systems based on the subset of data stored at that system, the queries anticipated to be received at that system, local (e.g., regional, national) preferences and/or regulatory or other requirements of a locale with which a given data access node is associated, different optimization parameters, different weighting of optimization parameters, etc. Each data ingestion and transformation module of systems 1604, 1606, and 1608 may perform transformations differently than one or more other data ingestion and transformation modules.

The systems may coordinate with each other to share optimizations. In various embodiments, the systems may coordinate with each other to self-organize to share work including by optimizing or transforming at a least a first portion at a first system and at least a second portion at a second system. As an example, consider a query A whose repeated execution becomes a sizeable part of data access node l's bandwidth. Node 1 optimizes the query as best it can, but determines that a restructuring of the data would make the query substantially faster. Node 1 creates a new representation of the data being queried that matches the queries' needs, comprising any subset of the full combination of data, index, and formatted results.

The benefits of data reorganization can be shared with other nodes as follows. In various embodiments, Node 1 shares the determination that this data reorganization would be beneficial with the data ingestion and transformation module 1. Module 1 then creates a data transformation usable by other systems 1606 and 1608 without requiring the other systems to perform all and/or part of the transformation work locally. When desired, either the data node or the transformation module of system 1604 may decide to change the data organization to suit current needs, such as reducing resource utilization, addressing a different query's needs, etc. Communications between the systems need not go through a transformation engine as various embodiments of the communication pathways are possible.

In various embodiments, the availability of services on instances (each of the systems 1604, 1606, and 1608) is based on configuration settings that include but are not limited to manual operation settings and/or model-based settings. Model-based settings include but are not limited to rule-based models and settings, machine-learning models and settings, and algebraic models and settings. A system may have the same, overlapping, or different rules compared with another system. The rules may vary based on context, time, clients accessing the particular instance, etc.

This system shows a data ingestion and transformation module at each pod, but other configurations are possible. For example, a data ingestion and transformation module is shared two or more systems 1602, 1604, and 1606 and each system includes a data access node.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system comprising:
a memory or other storage device configured to store an endpoint definition expressed in a declarative language; and
a processor coupled to the memory and configured to:
use the endpoint definition to dynamically generate an endpoint comprising a representational state transfer (REST) interface; and
provide access to a locally-stored database via the endpoint and REST interface.

2. The system of claim 1, wherein the system is an edge database server.

3. The system of claim 1, wherein the endpoint definition includes a specification defined entirely in a structured query language (SQL).

4. The system of claim 1, wherein the endpoint definition specifies a target and actions to be taken with respect to the target.

5. The system of claim 1, wherein generating the endpoint includes mapping components of is the REST interface to the endpoint definition.

6. The system of claim 5, wherein mapping components of the REST interface to the endpoint definition is based at least in part on paradigm and API information.

7. The system of claim 1, wherein generating the endpoint includes associating a specific structured query language (SQL) query with a REST interface action.

8. The system of claim 1, wherein the processor is further configured to deploy the endpoint including by sending the endpoint to at least one of data access node instances or a client requesting access to the locally-stored database.

9. The system of claim 1, wherein the processor is further configured to generate executable code.

10. The system of claim 1, wherein the processor is further configured to generate a universal API documentation specification of the endpoint.

11. The system of claim 1, wherein the processor is further configured to attach a security policy object to the generated endpoint.

12. The system of claim 11, wherein the processor is further configured to generate the security policy object including at least one of: protecting against cross-site request forger, validating input, securing output, managing encryption, or checking usage of HTTP codes.

13. The system of claim 11, wherein the processor is further configured to generate the security policy object including by converting permissions defined for database entity access to an equivalent REST access policy.

14. The system of claim 11, wherein the processor is further configured to dynamically determine a REST access policy by accessing an entity access policy for each request.

15. The system of claim 11, wherein the processor is further configured to determine a REST access policy based at least in part on REST access policies stored in a database entity.

16. The system of claim 11, wherein the processor is further configured to convert structured query language (SQL) entity access rules to REST rules by mapping a SQL privilege name to an associated REST action.

17. A method comprising:
using an endpoint definition to dynamically generate an endpoint comprising a representational state transfer (REST) interface, wherein the endpoint definition is expressed in a declarative language; and
providing access to a locally-stored database via the endpoint and REST interface.

18. The method of claim 17, wherein generating an endpoint includes mapping components of the REST interface to the endpoint definition.

19. The method of claim 17, wherein generating an endpoint includes associating a specific structured query language (SQL) query with a REST interface action.

20. A computer program product embodied in a non-transitory computer readable medium and comprising computer instructions for:
using an endpoint definition to dynamically generate an endpoint comprising a representational state transfer (REST) interface, wherein the endpoint definition is expressed in a declarative language; and
providing access to a locally-stored database via the endpoint and REST interface.
